(19) United States
(12) Patent Application Publication
(10) Pub. No.: US 2014/0130404 A1
(43) Pub. Date: May 15, 2014

(54) SYSTEM FOR CONVERTING ORGANIC MATERIALS INTO OIL, FUEL AND UNCONDENSED VAPORS UTILIZING A PYROLYSIS CHAMBER

(71) Applicant: MB Technologies, Las Vegas, NV (US)

(72) Inventor: Robert Brokaw, Las Vegas, NV (US)

(21) Appl. No.: 14/046,241

(22) Filed: Oct. 4, 2013

Related U.S. Application Data
(63) Continuation of application No. 61/709,406, filed on Oct. 4, 2012.

(51) Int. Cl. B01J 6/00

(52) U.S. Cl. CPC B01J 6/008
USPC 44/639

(57) ABSTRACT

A system and method for converting feedstock material into crude oil, lighter fuels such as diesel fuel, and uncondensed vapors such as natural gas. The material to be converted is properly sized and heated prior to be provided to a reactor. The heated feedstock is metered into the reactor where it is vaporized at a uniform temperature in an oxygen free environment. The reactor breaks down the carbon chains of the feedstock into strands of molecules containing less than 24 atoms per molecule. Any vaporized gas exits the reactor and enters a two-stage fractional distillation column which recovers the converted fuel.

### CROSS-REFERENCE TO RELATED APPLICATIONS

This application claims priority from U.S. Provisional Patent Application No. 61/709,406 entitled “System And Method For Converting Organic Materials Into Oil, Fuel And Uncondensed The Vapors”, filed on Oct. 4, 2012 which is incorporated fully herein by reference.

### TECHNICAL FIELD

The present invention relates to converting organic matter into fuel and more particularly, relates to a system and method for converting organic feedstock material into crude oil, lighter fuels such as diesel fuel, and uncondensed vapors such as propane gas utilizing a pyrolysis chamber.

### BACKGROUND INFORMATION

It is well known that this country is suffering from a shortage of reasonably priced fuel such as oil, diesel fuel and natural gas. It is also well known that this country produces a significant amount of waste material, much of the waste organic material such as sewage sludge, recycled paper, waste lumber, lumber pulp, woodchips, tires and even agricultural products and plastic.

Accordingly, a need exists for a system and method which can efficiently and economically convert organic material into energy products such as oil, fuel and uncondensed vapors such as propane gas.

### BRIEF DESCRIPTION OF THE DRAWINGS

These and other features and advantages of the present invention will be better understood by reading the following detailed description, taken together with the drawings wherein:

FIG. 1 is a schematic block diagram of the system of the present invention;

FIG. 2 a more detailed review of the twin agitator of the pyrolysis chamber of the invention; and

FIGS. 3A and 3B are detailed views of an exemplary feedstock dryer (FIG. 3A) and an exemplary shredder (FIG. 3B) in accordance with the teachings of the present invention.

### DETAILED DESCRIPTION OF THE PREFERRED EMBODIMENTS

The system and process of the present invention will convert organic feed stock materials (feed stock) using a continuous flow method into uncondensed vapors such as propane gas, and condensed fuels such as synthetic and/or bio-fuels including gasoline, kerosene, and diesel fuels. The process also produces char. The organic materials would include but are not limited to the following: sewage sludge, cellulose products (paper, lumber and lumber waste, pulp, and wood chips), yard wastes, algae, tires, agricultural products (corn, sugar beets, switch grass, palm oil, and vegetable oil), yellow grease, asphalt and most plastics (typically except PVC).

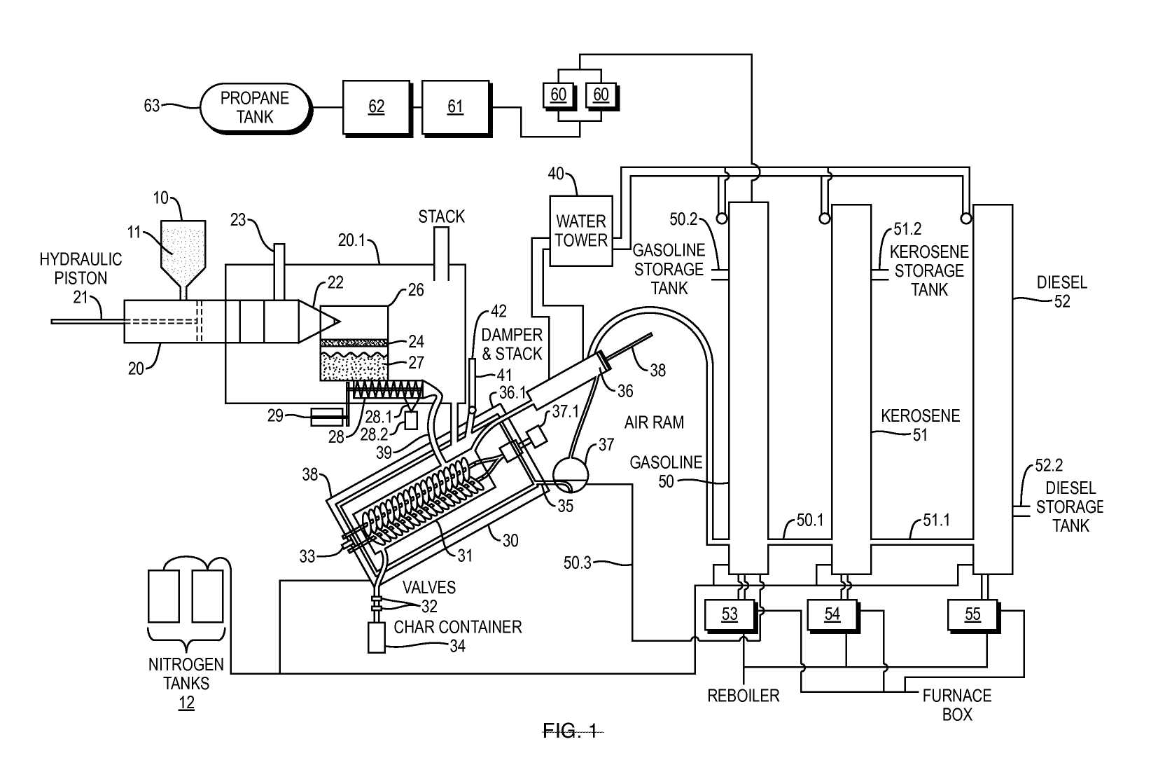

The outline of the system shown and described in accordance with in the enclosed FIG. 1 is intended to process plastics but could easily be modified to process the other items that are listed above. These modifications would generally be centered on how the feedstock is prepared and introduced into the reactor (pyrolysis chamber) and the position or “angle” of the pyrolysis chamber. There could also be modifications to the distillation tower and fuel cleaning process. All such modifications are considered to be within the knowledge of someone skilled in the art and are dependent on the type of feedstock.

For purposes of explaining the preferred embodiment of the present invention in connection with the drawings, the following designation of element numbers will be utilized:

FIG. 1
10) Feed Hopper
11) Feed Stock
20) Hydraulic Extruder
20.1) Extruder Furnace Box
21) Hydraulic Ram
22) Extruder Cone
23) Steam blow off valve
24) Screen
26) Melt Tank
27) Melted Feed Stock (Plastic)
28) Screw Monitor
28.1) Debris Bowl
28.2) Debris Container
29) Electric Motor
30) Pyrolysis Chamber
31) Twin Screw Agitator
32) Double Valve Assembly
33) Motor for Agitator
34) Char Container
35) Quencher Trap Tank Pipe
36) Quencher
36.1) Quencher Pipe
37) Quencher Trap Tank
37.1) Tube Burner
38) Air Ram for Char Cleaning
39) Melt Tank Screw Monitor Pipe
40) Water Cooling Tower
50) Distillation Column
51) Distillation Column
52) Distillation Column
60) Receiving Tank
61) Propane Scrubber
62) Propane Compressor
63) Propane Tank

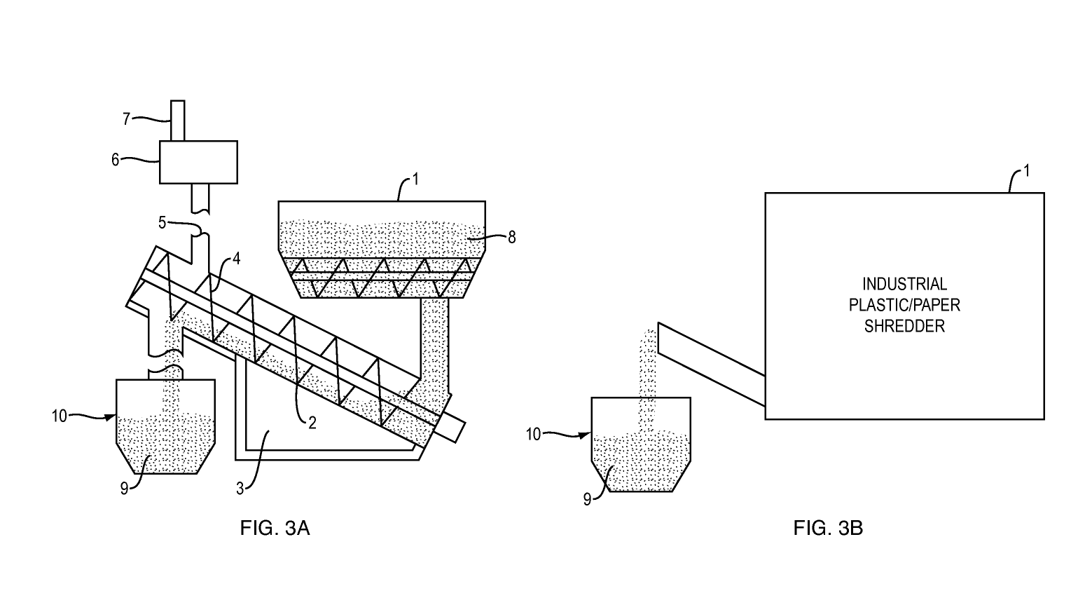

FIG. 3A (sewage sludge dryer)
1) Feed Hopper
2) Drying chamber
3) Heating chamber
4) Auger
5) Gas Discharge
6) Water Scrubber
7) Stack
8) Wet Sewage Sludge
9) Dry Sewage Sludge
10) Feedstock Bin

FIG. 3.2
1) Industrial Plastic/Paper/Wood Shredder
8) Feedstock
10) Feedstock Bin

The process according to the present invention includes and begins by placing the feedstock (10) into the feed hopper (11) after it is properly prepared. In the case of plastics, the feedstock would need to be separated (using a water bath for example to separate the heavier PVC plastic, metals and the like from other lighter plastic which can serve as feedstock for the present invention) and washed, dried, and shredded (see FIG. 3B) to a 2″ minus size and in the case of sewage sludge, it would need to be dried (see FIG. 3A). If PVC is included in the feed stock, an HCL scrubber (which is available commercially) would need to be placed between the screw-auger (28) and the reactor pipe (39) or removed completely from the feedstock as discussed above. Energy is supplied by a radiant tube burner (37) located at a pyrolysis chamber (30) and the three re-boilers (53) (54) (55) located under the distillation columns (50, 51 and 52). Pyrolysis is a thermochemical decomposition of organic material at elevated temperatures in the absence of oxygen (or any halogen). It involves the simultaneous change of chemical composition and physical phase. A key feature of the invention is the ability to introduce feedstock into the pyrolysis chamber on a continuous basis with generally absence of oxygen (air) such that the system of the invention can operate generally continuously.

Residual heat from the pyrolysis chamber furnace box (38) enters the furnace box (20.1) surrounding the melting tank (26) and the extruder (20) see FIG. 1. The feedstock is compressed and melted by friction and assisted with hot air diverted by means of a damper (41) located on the furnace box stack (42) from the pyrolysis chamber furnace box (38) in the hydraulic extruder (20). The melted feedstock (27) is screened (24) and stored and in the melting tank (26) at temperature of 250° C. The screen (24) is designed to remove unwanted debris such as metals and gravel/sand, from the process. The melted feed stock (27) is metered into the pyrolysis chamber (30) utilizing a variable speed screw (28) and connecting pipe (39). Any steam produced from water in the feed stock is vented through a blow off valve (23) or vented from the melting tank (26) where it is either condensed into water for use in the washing/drying process or it can be used to energize a steam generator (not shown) for electrical power. It should be noted that the melting process includes a screw feeder (28) that would discharge any foreign material not captured in the screen (24) in the melt tank. This debris would include metal and/or sand at and would be discharged at (28.1) and stored in a container (28.2).

The melted plastic (27) is metered and enters the pyrolysis reactor (30) near the top region of the chamber by means of conduit (39) where it is vaporized at a uniform temperature in the range of 600° C. The pyrolysis chamber is, in this embodiment, angled at approximately a 35 degree angle. It is contemplated that an angle of between 30 and 50 degrees could be utilized depending on the feedstock. The goal is to have the feedstock vaporize before the feedstock reaches the bottom or lower region of the pyrolysis chamber (30).

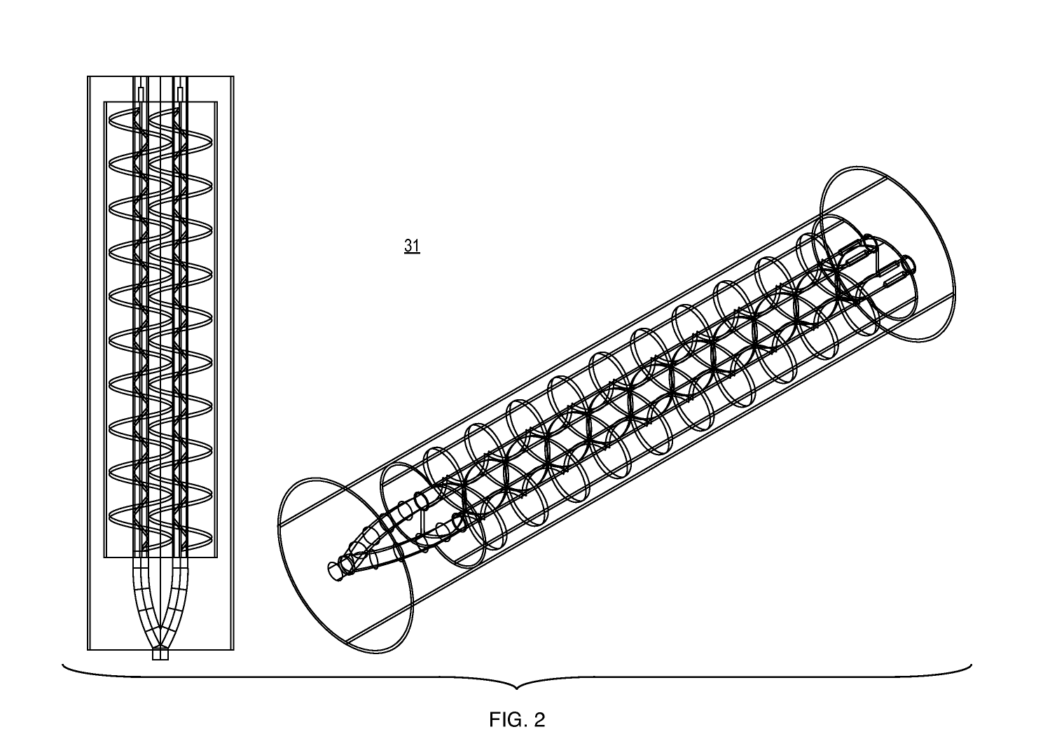

Energy is supplied from the radiant tube burner (37) to the pyrolysis chamber (30) and though the double self-cleaning screw tubing of the agitator (31) (see FIG. 2). Any char drops to the bottom of the pyrolysis chamber (30) into char container (34). Nitrogen (12) is introduced prior to system start up and on a continuous basis to assure the oxygen free reactor process inside the pyrolysis chamber (30). The twin screw self-cleaning agitator (31) is powered by an electric motor (33) that turns the feedstock to assure a uniform vaporization before the melted feedstock reaches the bottom of the reactor (30). The twin-screw self-cleaning agitator is designed with close tolerances between the auger blades themselves and the auger blades and the inside wall of the pyrolysis chamber in order to self-clean both the agitator blades and the inside wall of the pyrolysis chamber from any char that might otherwise accumulate. There is char produced in the reactor process and the twin screw agitator (31) scrapes the char from the walls of the reactor (30) and from the twin-screws (31) themselves where it accumulates and is stored in a container (34) after passing through a double valve assembly (32).

The goal of the oxygen free reactor process is to break the carbon chains (cracking) into strands of less than 24 atoms per molecule and vaporize the liquid plastic before it reaches the bottom of the chamber (30). The vaporized gas exits the reactor at point (36.1) and enters the quencher (36) where the vapors are cooled to 300° C., a temperature which will separate molecule chains of 24 atoms. Cooling water for the quencher (36) is supplied by the water tower (40). An air ram (38) periodically cleans the quencher (36) whereby any char that accumulates in the quencher (i.e. on the quencher walls) is forced back into the pyrolysis chamber (30). The molecules with more than 24 atoms are condensed in the quencher (36) where they drop into a quencher tank (37) and re-enter the pyrolysis chamber (30) at point (35), to be re-heated and re-cracked into shorter molecule chains. This process may be repeated until the molecule chains are shorter than 24 atoms in length. The quencher tank (37) is designed in such a way (i.e. “trapped”) that uncondensed gases cannot flow from the pyrolysis chamber (30) though the quencher tank (37) and up into the quencher (36). Those molecule chains with less than 24 atoms in length at the quencher (36) travel to the distillation column (50) where both propane and gasoline are separated. The propane, which is an uncondensed gas at ambient temperature, is transferred by pressure from the distillation column (50) to one of two receiving tanks (60) and then pumped by pressure to a scrubber (61) and compressed (62) and stored in the propane tank (63). This propane gas may then be used to fuel the furnace (71) which provides the majority of the energy to the plant.

The gasoline is outputted at (50.2) off the distillation column (50) and piped to a gasoline storage tank (not shown). The heat for the distillation column (50) is supplied by a radiant tube burner and a re-boiler located in a furnace box (53). Cooling for the tower is supplied by the water tower (40).

The liquid fuels for distillation column (51) are piped at (50.1) where the kerosene is distilled and piped (51.2) to a kerosene storage tank (not shown). The balance of the fuel is piped (51.1) to the third distillation column (52). The diesel is distilled and piped (52.2) to a diesel storage tank (not shown). Again, heat for the various distillation columns (53 and 53) is provided by the steam boiler (13) and transferred to the distillation columns (52, 53) through the kettle re-boilers (54) and (55). Cooling is provided by the water tower (40), as needed.

Any heavy oils in distillation column (50) are piped back to the pyrolysis chamber (30) through quencher tank (37) by means of piping (50.3) where they are re-cracked into shorter molecule chains and the process is repeated until all of the molecule chains are less the 24 atoms in length.

The pyrolysis chamber (30) is preferably fabricated from 309 Stainless Steel while the twin-screw agitator (31) is fabricated from either 309 Stainless Steel or some other high temperature material such as Inconel or Hastelloy. The selection of the materials will depend on the final temperatures selected for operating the pyrolysis chamber (30) which is influenced by the type of feed stock that is introduced into the system. Also, the distillation columns (50, 51 and 52) and all piping are constructed with stainless steel to reduce the potential of corrosion. The liquid fuels produced, i.e., gasoline, kerosene, and diesel, contain less than 15 ppm sulfur.

Please note that the distillation tower pans are designed with specific feed stocks in mind. Any significant change in the composition of the feed stocks would require modifications in the distillation process to accommodate the potential changes in temperatures to assure fuel output quality.

In another embodiment and in accordance with another feature of the present invention, the feedstock may include algae which can be introduced directly into the pyrolysis chamber (30). Algae is a renewable feedstock and thus there is great interest in utilizing algae to produce fuels. In accordance with this feature the present invention, algae may be not a waste product but rather, may be “grown” by feeding its sewage sludge or fertilizer. In this embodiment, it is contemplated that various gases which are undesirable to be released in the atmosphere such as carbon dioxide, carbon monoxide or nitrous oxide may be bubbled through the growing algae. The growing algae will consume the undesirable gases and release desirable oxygen into the atmosphere. It is contemplated that algae may be grown this way near the source of a significant amount of unwanted gases such as a powerplant or other manufacturing plant. This methodology would not only reduce the carbon footprint of the source of the unwanted gas but moreover, create, on a renewable basis, algae which could in turn be converted into by oh diesel using the system and methodology of the present invention.

Modifications and substitutions by one of ordinary skill in the art are considered to be within the scope of the present invention, which is not to be limited except by the allowed claims.

What is claimed is:

1. A system for converting, on a continuous basis, materials into oil, fuel and uncondensed vapors, said system comprising:
a generally continuous source of prepared feedstock material;
a pyrolysis chamber, coupled to said generally continuous source of prepared feedstock material, said pyrolysis chamber disposed at a predetermined angle and including a top region and a bottom region, and including a twin screw, self-cleaning agitator, said pyrolysis chamber coupled to said generally continuous source of prepared feedstock material and configured for providing a generally oxygen free chamber for receiving said generally continuous source of prepared feedstock material proximate said top region and for heating and vaporizing said prepared feedstock material, said vaporized feedstock material including carbon molecule strands, said pyrolysis chamber further configured for breaking and cracking said carbon molecule strands into carbon molecule strands of fewer than 24 atoms per molecule;
a quencher, coupled to said pyrolysis chamber, for receiving said vaporized feedstock material and for condensing said vaporized feedstock material into condensed liquid and uncondensed gas; and
one or more distillation columns, coupled to said quencher, and configured for separating said uncondensed gas from said condensed liquid, and for compressing and storing said uncondensed gas, and further configured for distilling said condensed liquid into one or more liquid fuels selected from the group of liquid fuels consisting of gasoline, kerosene and diesel fuel.

2. The system of claim 1 further including:
a feedstock material receiving device, for receiving, on an ongoing and continuous basis, previously prepared feedstock material;
means, coupled to said feedstock material receiving device, for liquefying and heating the feedstock material; and
means, coupled to said means for liquefying and heating the feedstock material, for providing said heated and liquefied feedstock material to said pyrolysis chamber.

3. A system of claim 1, wherein said uncondensed gas is propane gas.

4. The system of claim 1, wherein said feedstock material is selected from the group consisting of plastic, sewage sludge, algae, cellulose products (paper, lumber and lumber waste, pulp, and wood chips), yard wastes, tires, agricultural products (corn, sugar beets, switch grass, palm oil, and vegetable oil), yellow grease and asphalt.

5. The system of claim 1, wherein said pyrolysis chamber is coupled to a source of nitrogen gas which is introduced into said pyrolysis chamber, to purge said pyrolysis chamber of oxygen.

6. The system of claim 2, wherein said means, coupled to said means for liquefying and heating the feedstock material, for providing said heated and liquefied feedstock material to said pyrolysis chamber includes a screw auger and a pump.

7. The system of claim 1, wherein said one or more distillation columns include a gasoline fuel distillation column, a kerosene fuel distillation column and a diesel fuel distillation column.

8. A system for converting, on a continuous basis, materials into oil, fuel and uncondensed vapors, said system comprising:
a feedstock material receiving device, for receiving, on an ongoing and continuous basis, previously prepared feedstock material;
means, coupled to said feedstock material receiving device, for liquefying and heating the feedstock material;
a screw auger and a pump, coupled to said means for liquefying and heating the feedstock material, for providing said heated and liquefied feedstock material to a pyrolysis chamber;
a source of nitrogen gas, coupled to said pyrolysis chamber;
a pyrolysis chamber, coupled to said screw auger and pump and responsive to said received heated and liquefied feedstock material, said pyrolysis chamber disposed at a predetermined angle and including a top region and a bottom region, and including a twin screw, self-cleaning agitator, said pyrolysis chamber coupled to said means for providing said heated and liquefied feedstock material to a pyrolysis chamber and responsive to said source of nitrogen gas, and configured for providing a generally oxygen free chamber for receiving said heated and liquefied feedstock material proximate said top region and for heating and vaporizing said prepared feedstock material, said vaporized feedstock material including carbon molecule strands, said pyrolysis chamber further configured for breaking and cracking said carbon molecule strands into carbon molecule strands of fewer than 24 atoms per molecule;
a quencher, coupled to said pyrolysis chamber, for receiving said vaporized feedstock material and for condensing said vaporized feedstock material into condensed liquid and uncondensed gas; and
one or more distillation columns, coupled to said quencher, and configured for separating said uncondensed gas from said condensed liquid, and for compressing and storing said uncondensed gas, and further configured for distilling said condensed liquid into one or more liquid fuels selected from the group of liquid fuels consisting of gasoline, kerosene and diesel fuel.

9. A system for converting, on a continuous basis, materials into oil, fuel and uncondensed vapors, said system comprising:
a generally continuous source of prepared feedstock material;
a pyrolysis chamber, coupled to said generally continuous source of prepared feedstock material, said pyrolysis chamber disposed at a predetermined angle and including a top region and a bottom region, and including a twin screw, self-cleaning agitator, said pyrolysis chamber coupled to said generally continuous source of prepared feedstock material and configured for providing a generally oxygen free chamber for receiving said generally continuous source of prepared feedstock material proximate said top region and for heating and vaporizing said prepared feedstock material, said vaporized feedstock material including carbon molecule strands, said pyrolysis chamber further configured for breaking and cracking said carbon molecule strands into carbon molecule strands of fewer than 24 atoms per molecule;
a quencher, coupled to said pyrolysis chamber, for receiving said vaporized feedstock material and for condensing said vaporized feedstock material into condensed liquid and uncondensed gas; and
one or more distillation columns, coupled to said quencher, and configured for separating said uncondensed gas from said condensed liquid, and for compressing and storing said uncondensed gas, and further configured for distilling said condensed liquid into one or more liquid fuels selected from the group of liquid fuels consisting of gasoline, kerosene and diesel fuel.
